(19) United States
(12) Patent Application Publication
(10) Pub. No.: US 2010/0001934 A1
(43) Pub. Date: Jan. 7, 2010

(54) Display Panel and Multi-Branch Pixel Structure Thereof

(76) Inventors: Hon-Yuan Leo, Tainan (TW); Cheng-Chi Yen, Tainan (TW)

Correspondence Address: Nixon Peabody LLP, 200 Page Mill Road, Suite 200, Palo Alto, CA, 94306, US

(21) Appl. No.: 12/168,067

(22) Filed: Jul. 4, 2008

(51) Int. Cl. G09G 3/36; G09G 3/20

(52) U.S. Cl. 345/87; 345/55

(57) ABSTRACT

A multi-branch pixel structure of display panel, such as LCoS, is disclosed. Each pixel cell of the display panel has at least two branches. The display panel has a pair of sub-data lines for each column of the pixel cells, and the sub-data lines are controllably coupled to the two branches respectively. The two branches enter an addressing mode and a displaying mode in turn, thereby substantially increasing operating speed and reducing coupling effect.

### BACKGROUND OF THE INVENTION

1. Field of the Invention

The present invention generally relates to a display panel, and more particularly to a system and method of driving a liquid crystal on silicon (LCoS) panel with multi-branch pixel structure.

2. Description of the Prior Art

Liquid crystal on silicon (LCoS or LCOS) is a reflective technology that can produce higher resolution image, at lower cost, than liquid crystal display (LCD), and has been developed as the optical engine for micro-projection or micro-display system. Similar to the structure of LCD, the LCoS typically includes rows and columns of picture elements (or pixels) arranged in matrix form. Each pixel unit cell 10 as shown in FIG. 1 includes a transistor QA, which is addressed by a scan signal (Scan) on a scan line 12 (or gate line). The pixel unit cell 10 also includes a storage capacitor C, which is designed to receive and store image data (Data) provided by a data line 14 (or source line) via the transistor QA. The gates of the transistors QA in the same row are connected together through the scan line 12, and controlled by a scan driver or gate driver (not shown). The sources of the transistors QA in the same column are connected together through the data line 14, and controlled by a data driver or source driver (not shown). In the operation, the transistor QA is firstly addressed by the scan signal (Scan), such that the transistor QA is turned on and the image data can be stored in the storage capacitor C. Subsequently, the charge in the storage capacitor C is then transferred and displayed.

Operating speed is one of the issues to be improved on the LCoS or other display system, for the reason that liquid crystal needs time to respond to the image data. This issue demands more stringent attention when the LCoS resolution increases. For the foregoing reason, a need has arisen to propose a novel structure to substantially increase LCoS operating speed.

### SUMMARY OF THE INVENTION

In view of the foregoing, it is an object of the present invention to provide a novel system and method of driving a multi-branch flat panel display, such as LCoS, for substantially increasing operating speed and reducing coupling effect.

According to one embodiment of the present invention, a multi-branch pixel structure of display panel, such as LCoS, has a number of pixel cells arranged in matrix form, each pixel cell having at least two branches. The two branches enter an addressing mode and a displaying mode in turn. The display panel has a pair of sub-data lines for each column of the pixel cells, and the sub-data lines are controllably coupled to the two branches respectively. In operation, the first branch is addressed, in a frame, such that image data provided on the first sub-data line is transferred and stored in the first branch, while the stored image data of the second branch is displayed. Subsequently, the second branch is addressed, in a neighboring frame, such that image data provided on the second sub-data line is transferred and stored in the second branch, while the stored image data of the first branch is displayed.

### BRIEF DESCRIPTION OF THE DRAWINGS

FIG. 1 illustrates a pixel unit cell of a conventional LCoS;

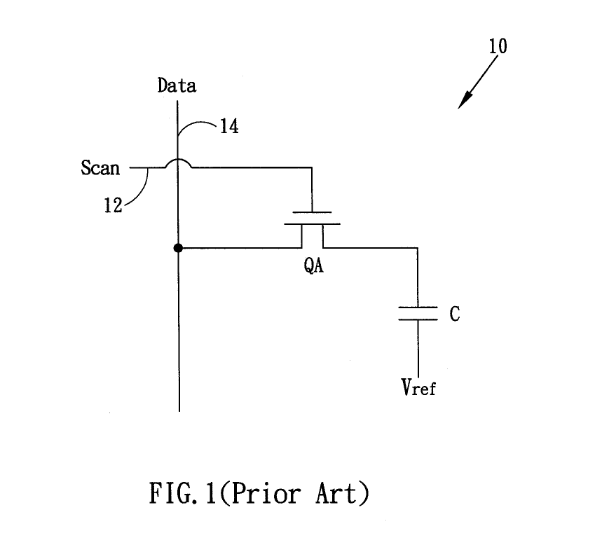

FIG. 2A illustrates a multi-branch pixel structure of the invention;

FIG. 2B illustrates a pixel unit cell of the multi-branch pixel structure of FIG. 2A;

FIG. 3A and FIG. 3B illustrate the operation of the pixel unit cell of FIG. 2B;

FIG. 4 shows an exemplary timing diagram illustrating the operation associated with FIG. 3A and FIG. 3B;

FIG. 5 shows the LCoS operation like that illustrated in FIG. 3A, while unwanted parasitic capacitance Cds of the addressing transistor QA_{B} has been taken into consideration;

FIG. 6A illustrates a multi-branch pixel structure according to one embodiment of the present invention;

FIG. 6B illustrates a pixel unit cell of the multi-branch pixel structure of FIG. 6A;

FIG. 7A and FIG. 7B illustrate the operation of the pixel unit cell of FIG. 6B; and

FIG. 8 shows an exemplary timing diagram illustrating the operation associated with FIG. 7A and FIG. 7B.

### DETAILED DESCRIPTION OF THE INVENTION

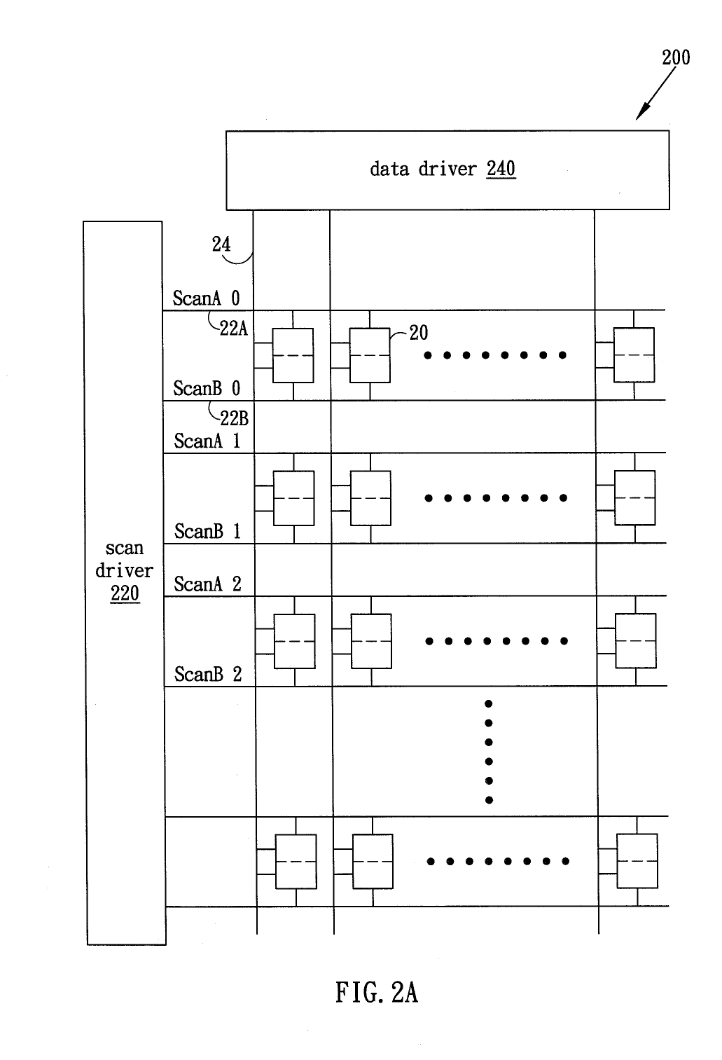

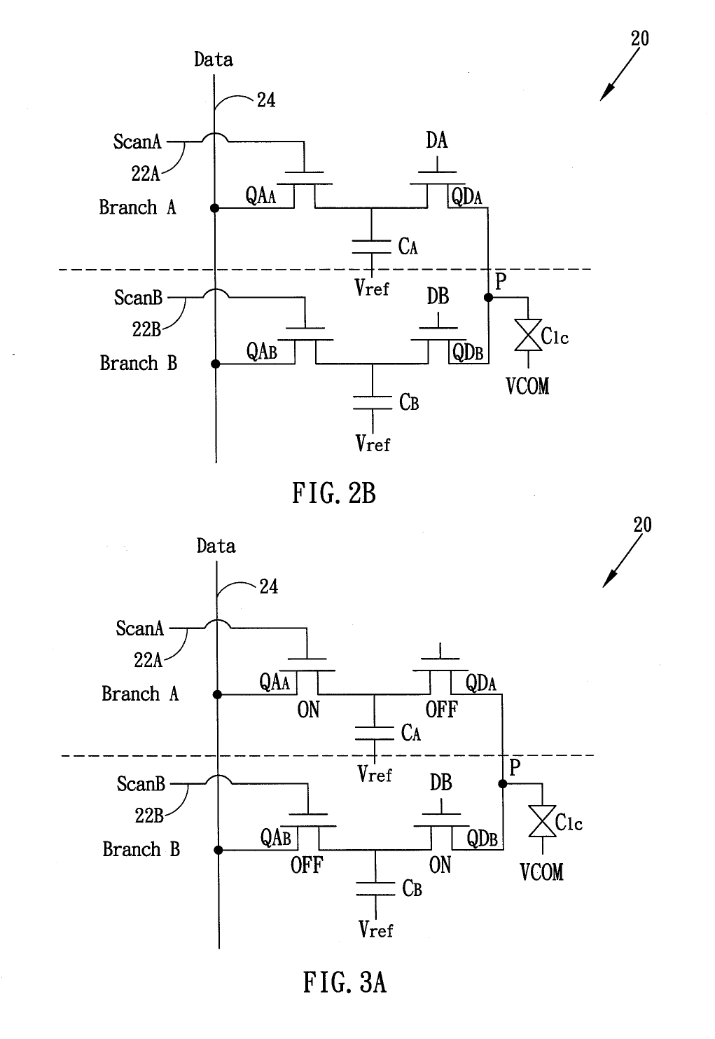

FIG. 2A illustrates a multi-branch pixel structure of the liquid crystal on silicon (LCoS or LCOS) panel 200, and FIG. 2B illustrates one of the pixel unit cells 20 of the multi-branch pixel structure in FIG. 2A. Although the LCoS is illustrated here, it is appreciated by those skilled in the pertinent art that the illustrated structure can be well adapted to other reflective/transmissive flat panel display, such as liquid crystal display (LCD). Referring to FIG. 2A, the LCoS panel 200 includes rows and columns of picture elements (or pixels) or pixel cells 20 arranged in matrix form. The pixel cells 20 in the same row are under control of scan signals (ScanA n and ScanB n, n=0, 1, 2, etc.) on the scan lines (or gate lines) 22A and 22B; while the pixel cells 20 in the same column are electrically coupled to a data line (or source line) 24. The scan lines 22A and 22B are controlled by a scan (or gate) driver 220, and the data lines 24 are controlled by a data (or source) driver 240.

Referring to FIG. 2B, the pixel unit cell 20 includes at least two branches, that is Branch A and Branch B. Take the Branch A as an example, it includes an addressing transistor QA_{A}, such as metal-oxide-semiconductor (MOS) transistor, which is configured to be addressed, for example, via the gate of the addressing transistor QA_{A}, by a scan signal (ScanA) on the scan line 22A. Specifically, one end, such as the source, of the channel of the addressing transistor QA_{A} is electrically coupled to the data line 24.

The Branch A also includes a storage capacitor C_{A}, which is configured to receive image data on the data line 24 via the addressing transistor QA_{A}. Specifically, one end of the storage capacitor C_{A} is electrically coupled to the other end, such as the drain, of the channel of the addressing transistor QA_{A}. The other end of the storage capacitor C_{A} is electrically coupled to a reference voltage Vref or the ground.

The Branch A further includes a displaying transistor QD_{A}, such as MOS transistor, through which the stored image data in the storage capacitor C_{A} is displayed. The displaying transistor QD_{A} is configured to buffer the stored image data until the startup of the display. Specifically, the gate of the displaying transistor QD_{A} is controlled by a control signal DA. One end, such as the source, of the channel of the displaying transistor QD_{A} is electrically coupled to the drain of the addressing transistor QA_{A}, and coupled to one end of the storage capacitor C_{A}. Another end, such as the drain, of the channel of the displaying transistor QD_{A} is electrically coupled to a pixel electrode P. A liquid crystal capacitor C_{1c} equivalently represents a liquid crystal capacitance connected between the pixel electrode P and a common electrode. The common electrode provided at the display panel is arranged to face the pixel electrode P in an opposed manner and coupled to a common voltage VCOM. The stored image data applies to the corresponding pixel electrode P and alters the transparency or reflectivity of the liquid crystal overlies thereon. The description about the Branch A applies to the addressing transistor QA_{B}, the storage capacitor C_{B}, the displaying transistor QD_{B}, the scan signal (ScanB) and the control signal DB in the Branch B.

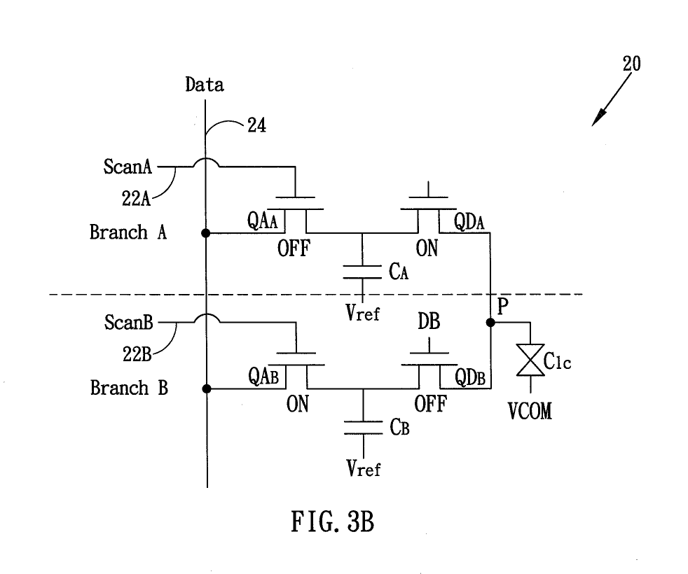

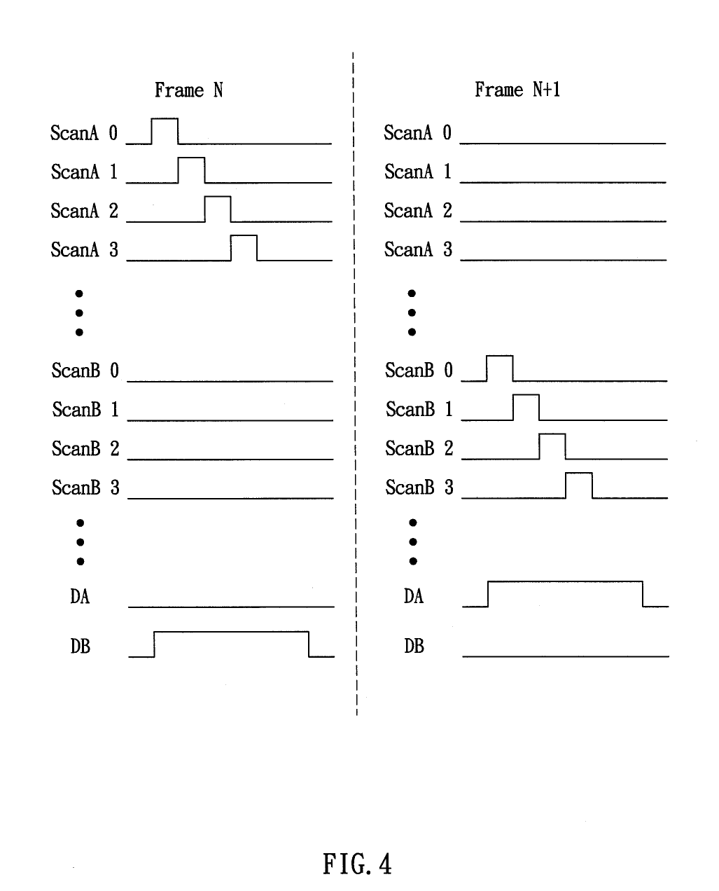

FIG. 3A and FIG. 3B illustrate the operation of the pixel unit cell 20 of FIG. 2B. FIG. 4 shows an exemplary timing diagram illustrating the operation associated with FIG. 3A and FIG. 3B.

In FIG. 3A and the Frame N in FIG. 4, the Branch A enters an addressing mode, during which the scan signal (ScanA) turns on the addressing transistor QA_{A}, such that the image data (Data) provided along the data line 24 could be stored in the storage capacitor C_{A}. At the same time, the displaying transistor QD_{A} is turned off by the logic-low control signal DA to prevent the stored image data from affecting the other branch (Branch B). The scan driver 220 generates sequential scan signals (ScanA 0, ScanA 1, ScanA 2, etc.) to scan (or address) each row of pixel cells 20 in sequence, for example, from top to bottom.

While the Branch A enters the addressing mode, the Branch B, otherwise, enters a displaying mode, in which the logic-low scan signal (ScanB 0, ScanB 1, ScanB 2, etc.) turns off the addressing transistor QA_{B} while the logic-high control signal DB turns on the displaying transistor QD_{B}, such that the image data stored in the storage capacitor C_{B} from the previous frame (not shown) could be displayed.

Subsequently, referring to FIG. 3B and the Frame N+1 in FIG. 4, the Branch A now enters the displaying mode, in which the logic-low scan signal (ScanA 0, ScanA 1, ScanA 2, etc.) turns off the addressing transistor QA_{A} while the logic-high control signal DA turns on the displaying transistor QD_{A}, such that the image data stored in the storage capacitor C_{A} from the previous Frame N could be displayed.

While the Branch A enters the displaying mode, the Branch B, otherwise, enters the addressing mode, during which the scan signal (ScanB) turns on the addressing transistor QA_{B}, such that the image data (Data) provided along the data line 24 could be stored in the storage capacitor C_{B}. At the same time, the displaying transistor QD_{B} is turned off by the logic-low control signal DB to prevent the stored image data from affecting the other branch (Branch A). The scan driver 220 generates sequential scan signals (ScanB 0, ScanB 1, ScanB 2, etc.) to scan (or address) each row of pixel cells 20 in sequence, for example, from top to bottom.

According to the multi-branch pixel structure of the LCoS panel 200 disclosed above, in which the addressing and displaying could be exercised at the same time in different branches respectively, the operating speed thus could be substantially increased.

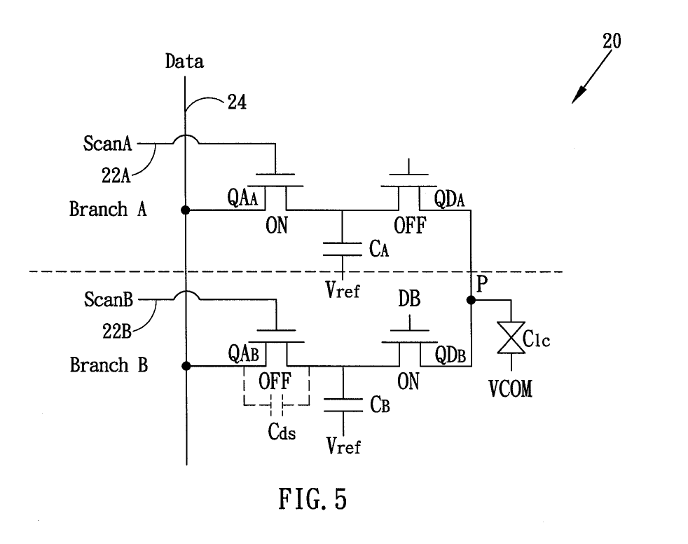

FIG. 5 shows the operation of the pixel unit cell 20 like that illustrated in FIG. 3A, while unwanted parasitic capacitance Cds of the addressing transistor QA_{B} has been taken into consideration. The parasitic capacitance Cds unfortunately couples the image data on the data line 24 to the storage capacitor C_{B}, thereby contaminating the stored charge in the storage capacitor C_{B} and thus lowering the display quality.

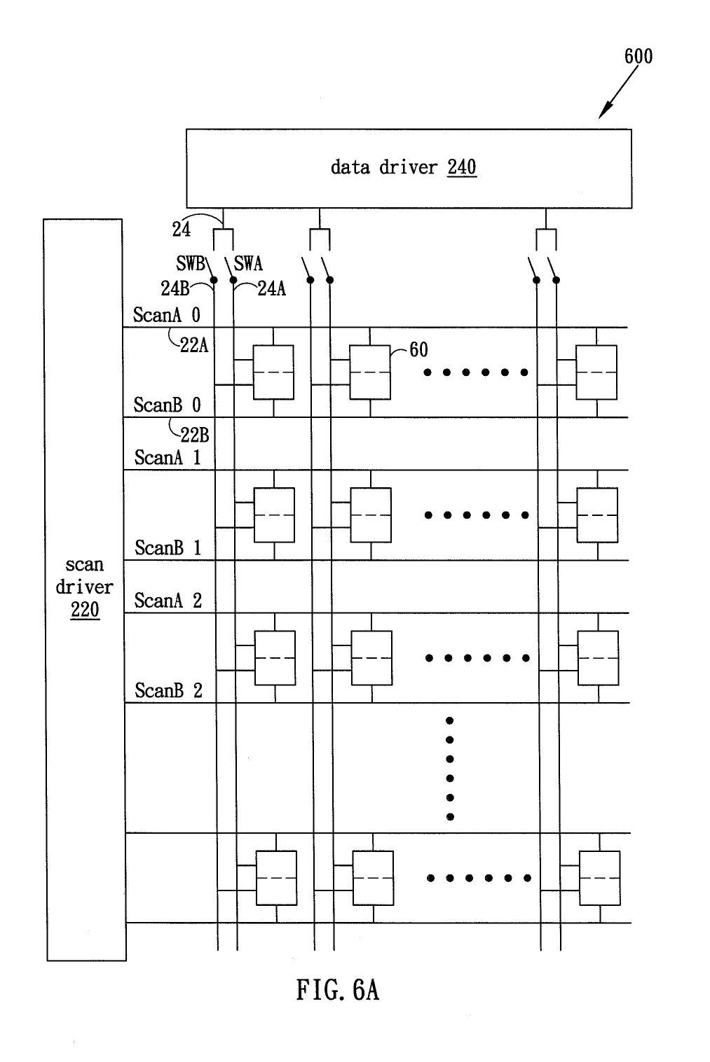

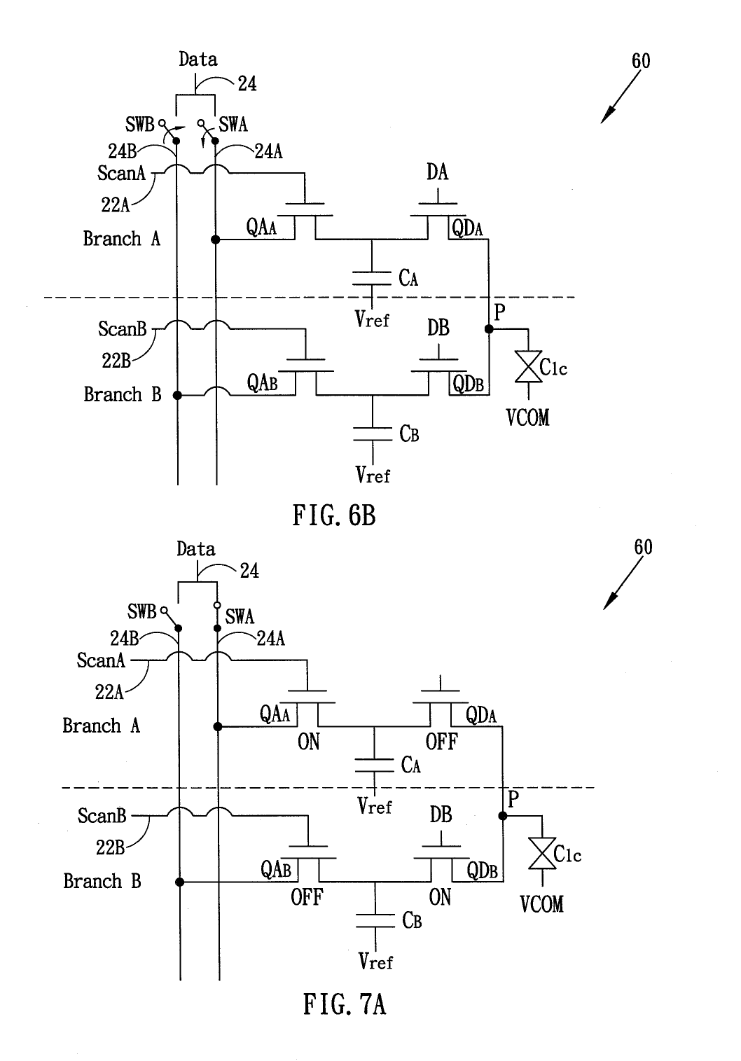

FIG. 6A illustrates a multi-branch pixel structure of the LCOS panel 600 according to one embodiment of the present invention, and FIG. 6B illustrates one of the pixel unit cells 60 of the multi-branch pixel structure in FIG. 6A. The multi-branch pixel structure of the LCoS panel 600 is designed to improve the coupling effect of the LCoS panel 200 mentioned previously, while sustaining its advantage—high operating speed. Components in FIG. 6A and FIG. 6B similar to those in FIG. 2A and FIG. 2B use the same reference numerals or letters. Although the LCoS is illustrated here, it is appreciated by those skilled in the pertinent art that the illustrated structure can be well adapted to other flat panel display, such as LCD. Referring to FIG. 6A, the LCoS panel 600 includes rows and columns of picture elements (or pixels) or pixel cells 60 arranged in matrix form. The pixel cells 60 in the same row are under control of scan signals (ScanA n and ScanB n, n=0, 1, 2, etc.) through scan lines 22A and 22B; while the pixel cells 60 in the same column are electrically coupled to a pair of sub-data lines (24A and 24B). The sub-data lines (24A and 24B) in each pair collectively merge, via a pair of switches (SWA and SWB), into a single data line 24. The scan lines 22A and 22B are controlled by a scan (or gate) driver 220, and the data lines 24 are controlled by a data (or source) driver 240.

Referring to FIG. 6B, the pixel unit cell 60 includes at least two branches, that is Branch A and Branch B in the embodiment. Take the Branch A as an example, it includes an addressing transistor QA_{A}, which is configured to be addressed, for example, via the gate of the addressing transistor QA_{A}, by a scan signal (ScanA) on the scan line 22A. Specifically, one end, such as the source, of the channel of the addressing transistor QA_{A} is electrically coupled to the data line 24A, which is connected to the sub-data line 24A.

The Branch A also includes a storage capacitor C_{A} and a displaying transistor QD_{A}, which have the same configuration as those in FIG. 2B and their descriptions are thus omitted here for brevity.

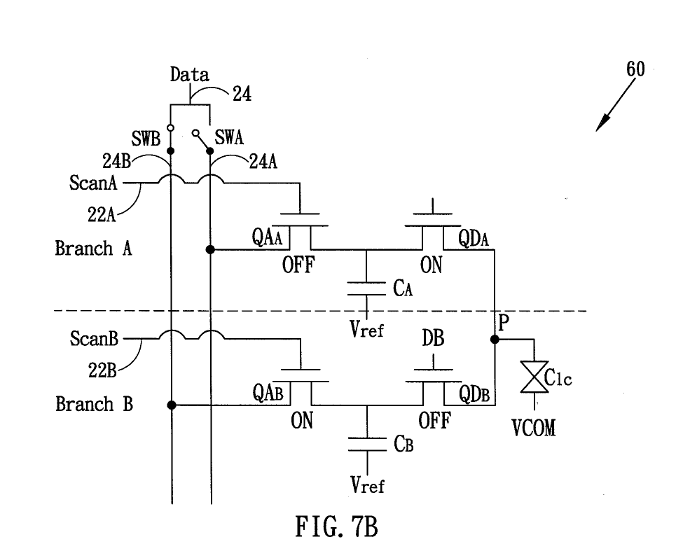

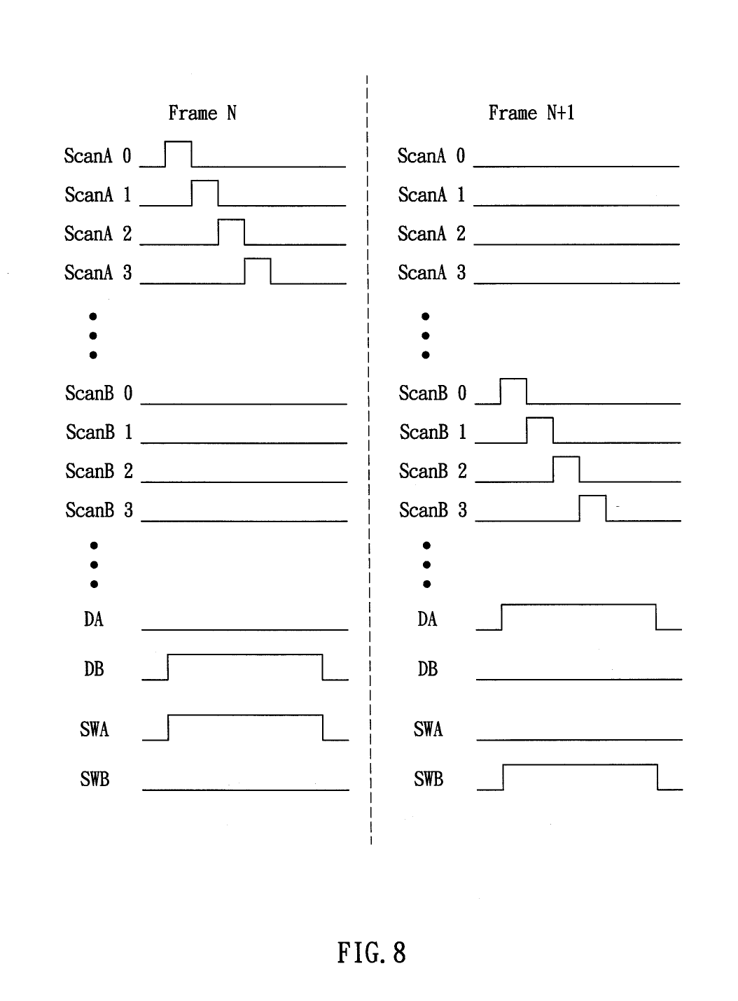

FIG. 7A and FIG. 7B illustrate the operation of the pixel unit cell 60 of FIG. 6B. FIG. 8 shows an exemplary timing diagram illustrating the operation associated with FIG. 7A and FIG. 7B.

In FIG. 7A and the Frame N in FIG. 8, the Branch A enters an addressing mode, during which the scan signal (ScanA) turns on the addressing transistor QA_{A}, the switch SWA associated with the Branch A is close, and the switch SWB associated with the Branch B is open, such that the image data (Data) provided along the data line 24 and the sub-data line 24A could be stored in the storage capacitor C_{A}. At the same time, the displaying transistor QD_{A} is turned off by the logic-low control signal DA to prevent the stored image data from affecting the other branch (Branch B). The scan driver 220 generates sequential scan signals (ScanA 0, ScanA 1, ScanA 2, etc.) to scan (or address) each row of pixel cells 60 in sequence, for example, from top to bottom.

While the Branch A enters the addressing mode, the Branch B, otherwise, enters a displaying mode, in which the logic-low scan signal (ScanB 0, ScanB 1, ScanB 2, etc.) turns off the addressing transistor QA_{B} while the logic-high control signal DB turns on the displaying transistor QD_{B}, such that the image data stored in the storage capacitor C_{B} from the previous frame (not shown) could be displayed.

Subsequently, referring to FIG. 7B and the Frame N+1 in FIG. 8, the Branch A now enters the displaying mode, in which the logic-low scan signal (ScanA 0, ScanA 1, ScanA 2, etc.) turns off the addressing transistor QA_{A} while the logic-high control signal DA turns on the displaying transistor QD_{A}. Further, the switch SWA associated with the Branch A is open, and the switch SWB associated with the Branch B is close, such that the image data stored in the storage capacitor C_{A} from the previous Frame N could be displayed.

While the Branch A enters the displaying mode, the Branch B, otherwise, enters the addressing mode, during which the scan signal (ScanB) turns on the addressing transistor QA_{B}, such that the image data (Data) provided along the data line 24 and the sub-data line 24B could be stored in the storage capacitor C_{B}. At the same time, the displaying transistor QD_{B} is turned off by the logic-low control signal DB to prevent the stored image data from affecting the other branch (Branch A). The scan driver 220 generates sequential scan signals (ScanB 0, ScanB 1, ScanB 2, etc.) to scan (or address) each row of pixel cells 60 in sequence, for example, from top to bottom.

According to the multi-branch pixel structure of the LCoS panel 600 disclosed above, in which the addressing and displaying could be exercised at the same time in different branches respectively, the operating speed thus could be substantially increased. Furthermore, as the sub-data lines 24A and 24B are respectively connected to the addressing transistor QA_{A} and the addressing transistor QA_{B}, the data line coupling effect demonstrated in FIG. 5 is thus eliminated, or at least is substantially improved.

Although specific embodiments have been illustrated and described, it will be appreciated by those skilled in the art that various modifications may be made without departing from the scope of the present invention, which is intended to be limited solely by the appended claims.

What is claimed is:

1. A system for driving a display panel, comprising:
a plurality of pixel cells arranged in matrix form, each of the pixel cells having at least two branches, wherein the two branches enter an addressing mode and a displaying mode in turn; and
a pair of sub-data lines for each column of the pixel cells, the sub-data lines being controllably coupled to the two branches respectively.

2. The system of claim 1, wherein the display panel is liquid crystal on silicon (LCoS).

3. The system of claim 1, wherein the sub-data lines of the pair controllably merge into a single data line.

4. The system of claim 3, further comprising a pair of switches respectively configured to control associated connection between the single data line and the two branches.

5. The system of claim 1, further comprising at least two scan lines for each row of the pixel cells, wherein the two branches of the pixel cell are associatively coupled to the two scan lines respectively.

6. The system of claim 5, wherein each of the pixel cells comprises:
an addressing transistor, configured to be addressed by the associated scan line;
a storage capacitor, configured to receive image data on the associated sub-data line and then store the image data therein; and
a displaying transistor, through which the stored image data is displayed.

7. The system of claim 6, wherein:
a gate of the addressing transistor is coupled to the associated scan line;
a first end of channel of the addressing transistor is coupled to the associated sub-data line; and
a second end of the channel of the addressing transistor is coupled to one end of the storage capacitor.

8. The system of claim 7, wherein:
a gate of the displaying transistor is coupled to a control signal that starts up the displaying mode;
a first end of channel of the displaying transistor is coupled to the second end of the channel of the addressing transistor; and
a second end of the channel of the displaying transistor is coupled to a pixel electrode.

9. The system of claim 6, further comprising:
means for providing scan signals to address the addressing transistors of one of the branches, while turning off the addressing transistors of another one of the branches; and
means for providing control signals to the displaying transistors of one of the branches to turn off the displaying transistors in one of the branches, while starting up the displaying mode in another one of the branches.

10. A method of driving a display panel, which has a plurality of pixel cells arranged in matrix form, each of the pixel cells having at least a first branch and a second branch, wherein a first sub-data line is controllably associated with the first branch and a second sub-data line is controllably associated with the second branch, said method comprising:
addressing the first branch, in a frame, such that image data provided on the first sub-data line is transferred and stored in the first branch, while displaying stored image data of the second branch; and
addressing the second branch, in a neighboring frame, such that image data provided on the second sub-data line is transferred and stored in the second branch, while displaying the stored image data of the first branch.

11. The method of claim 10, wherein the display panel is liquid crystal on silicon (LCoS) panel.

12. The method of claim 10, wherein the image data is stored in a storage capacitor of the first or the second branch.

13. The method of claim 10, further comprising:
buffering the stored image data of the first branch while the first branch is being addressed; and
buffering the stored image data of the second branch while the second branch is being addressed.

14. The method of claim 13, wherein the stored image data is buffered by preventing the stored image data from being connected to a pixel electrode.

15. The method of claim 13, wherein:
the first branch in a row is addressed by a first scan signal on a first scan line; and
the second branch in the same row is addressed by a second scan signal on a second scan line.

16. The method of claim 15, wherein:
the image data on the first sub-data line is transferred to the first branch in a column through a first switch; and
the image data on the second sub-data line is transferred to the second branch in the same column through a second switch.
